(19) United States
(12) Patent Application Publication
(10) Pub. No.: US 2014/0265716 A1
(43) Pub. Date: Sep. 18, 2014

(54) SOFT MAGNETIC CORE AND MOTOR INCLUDING THE SAME

(71) Applicant: SAMSUNG ELECTRO-MECHANICS CO., LTD., Suwon (KR)

(72) Inventors: Hak Kwan KIM, Suwon (KR); Sung Yong AN, Suwon (KR); No Il PARK, Suwon (KR); Dong Hyeok CHOI, Suwon (KR)

(73) Assignee: SAMSUNG ELECTRO-MECHANICS CO., LTD., Suwon (KR)

(21) Appl. No.: 13/897,174

(22) Filed: May 17, 2013

(30) Foreign Application Priority Data
Mar. 14, 2013 (KR) 10-2013-0027532

(51) Int. Cl. H01F 3/08; H02K 1/00

(52) U.S. Cl. CPC H01F 3/08; H02K 1/00
USPC 310/216.067; 335/297

(57) ABSTRACT

There is provided a soft magnetic core including: soft magnetic powder particles having an insulating coating layer formed on surfaces thereof and metal powder particles positioned between the soft magnetic powder particles.

### CROSS-REFERENCE TO RELATED APPLICATIONS

This application claims the priority of Korean Patent Application No. 10-2013-0027532 filed on Mar. 14, 2013, in the Korean Intellectual Property Office, the disclosure of which is incorporated herein by reference.

### BACKGROUND OF THE INVENTION

1. Field of the Invention

The present invention relates to a soft magnetic core and a motor including the same, and more particularly, to a soft magnetic core having improved electrical properties and magnetic flux density and a motor including the same.

2. Description of the Related Art

Generally, a soft magnetic material has had various applications, for example, in an inductor core, in a stator, in a rotor, and in an actuator of an electrical apparatus such as a motor, in a sensor, and in a transformer core.

According to the related art, a method, in which processed steel plates are stacked in several layers and are then fixed to one another so as to be integrated has been used as a method of manufacturing soft magnetic cores used as elements of electrical apparatuses.

However, in the case of manufacturing a soft magnetic core by stacking steel plates, it may be difficult to manufacture a product having a relatively complicated three-dimensional shape and a large amount of scrap loss may be generated.

Therefore, a method for high-pressure molding of a soft magnetic powder has recently been introduced and a core having a higher degree of freedom in terms of a shape thereof may be manufactured.

The soft magnetic powder used in this case, a powder having magnetic properties when electricity is applied thereto, is typically based on iron-based soft magnetic powder particles and the manufacturing of the soft magnetic core using the soft magnetic powder particles is performed through typical metallurgical powder processing.

The soft magnetic powder capable of being appropriately used as a core material may be manufactured by converting an iron-based soft magnetic material into a powder using a spraying method or a grinding method and then performing mechanical machining and a heat treatment on the powder.

In general, the soft magnetic powder manufactured as described above is coated with a mixed ceramic or an epoxy, such that an insulating coating may be performed thereon.

By performing the insulating coating on the soft magnetic powder as described above, the soft magnetic powder particles form a typical soft magnetic composite (SMC).

The soft magnetic powder particles having an insulating coating layer prepared as described above are pressed and molded using a pressing machine, such as a compression molding machine, and a soft magnetic core body molded to have a desired shape is formed through the processes as described above.

In the case of a soft magnetic core formed of the soft magnetic composite according to the related art, since the powder particles are only molded through the pressurization thereof and are not in a state in which sintering has been undertaken thereon, the soft magnetic composite core may easily broken due to an external impact.

Particularly, in the case of a core for a motor, when performing winding work, the possibility that a portion of the core will be broken may be high.

In the case of a general soft magnetic composite core for low core loss, there is a limit to increase molding density at the time of manufacturing thereof. Therefore, a level of density needed to be realized in products may not be able to be implemented.

In the case in which only a pure iron powder having excellent moldability is used at the time of press-molding, a molding density of the molded body is excellent at about 7.6 g/cc and a molding intensity is also high at 100 MPa or more, but the core loss is increased in a frequency range of 400 Hz or more, compared to an Fe—Si or an Fe—Si—B based core.

Particularly, the core loss may be sharply increased within a frequency range of kHz.

Further, due to a decrease in frictional force between powder particles and a decrease in frictional force between the powder particles and a surface of a molding apparatus, it may be difficult to secure a sufficient molding density value.

In addition, in the case of increasing molding pressure in order to secure the molding density, the insulating coating layer is broken and cracks, and the like may occur in a mold wall and the molding apparatus, such that a lifespan of the mold may be decreased and several characteristics of the molding body are degraded.

At the time of applying this core to the motor, since characteristics and efficiency of the motor are decreased, the limitation on the use thereof according to a usable frequency region is increased.

In addition, in the case in which the core is manufactured using a Fe—Si or an Fe—Si—B based amorphous powder, since the amorphous powder particles themselves are easily broken as compared to pure iron powder particles, the molding density and saturation magnetic flux density thereof may be low. In addition, since the intensity is not high, it is difficult to apply the amorphous powder to the core of a small motor such as a hard disk drive (HDD).

Therefore, in order to solve the above-mentioned defects, a soft magnetic core resistant to external impacts is required.

In addition, there is a need to increase magnetic flux density in order to improve performance of the motor and increase intensity and electrical properties of the core.

Patent Document 1 described in the following related art document is an invention, relating to a soft magnetic material, a compressed powder core, and a method for manufacturing the soft magnetic material.

Patent Document 1 discloses a metal magnetic particle and an insulation film coating the metal magnetic particle, but does not disclose a method for increasing the intensity and electrical properties of the core.

### RELATED ART DOCUMENT

(Patent Document 1) Korean Patent Laid-Open Publication No. 2007-0030846

### SUMMARY OF THE INVENTION

An aspect of the present invention provides a soft magnetic core having improved intensity by enhancing electrical properties thereof and a motor including the same.

In addition, another aspect of the present invention provides a soft magnetic core allowing for increases in magnetic flux density and intensity thereof and a motor including the same.

According to an aspect of the present invention, there is provided a soft magnetic core, including: soft magnetic powder particles having an insulating coating layer formed on respective surfaces thereof; and metal powder particles disposed between the soft magnetic powder particles.

The metal powder particles may be formed of pure iron or an alloy including iron.

The soft magnetic powder particles may be formed of one or more selected from a group consisting of pure iron (Fe), cobalt (Co), nickel (Ni), and Permalloy.

The soft magnetic powder particles having the insulating coating layer may have an average diameter of 50 μm to 200 μm.

The insulating coating layer may have a thickness of 50 nm to 1000 nm.

The insulating coating layer may include a ceramic or an insulating resin.

The ceramic may be one or more selected from a group consisting of ferrite, silicon dioxide, sodium silicate, and magnesium oxide.

The insulating resin may be an epoxy resin.

A weigh ratio of the soft magnetic powder particles to the metal powder particles may be 7:3.

According to another aspect of the present invention, there is provided a motor, including: a soft magnetic core including soft magnetic powder particles having an insulating coating layer formed on respective surfaces thereof, and metal powder particles disposed between the soft magnetic powder particles; a coil wound around the soft magnetic core; a magnet allowing electromagnetic force to be generated through interactions between the magnet and the coil; and a rotor rotating a shaft using the electromagnetic force.

The metal powder particles may be formed of pure iron or an alloy including iron.

The soft magnetic powder particles may be formed of one or more selected from a group consisting of pure iron (Fe), cobalt (Co), nickel (Ni), and Permalloy.

The soft magnetic powder particles having the insulating coating layer may have an average diameter of 50 μm to 200 μm.

The insulating coating layer may have a thickness of 50 nm to 1000 nm.

The insulating coating layer may include a ceramic or an insulating resin.

The ceramic may be one or more selected from a group consisting of ferrite, silicon dioxide, sodium silicate, and magnesium oxide.

The insulating resin may be an epoxy resin.

A weight ratio of the soft magnetic powder particles to the metal powder particles may be 7:3.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a motor including a soft magnetic core according to an embodiment of the present invention; and

FIG. 2 is a schematic perspective view illustrating a soft magnetic core according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Motor

FIG. 1 is a schematic perspective view illustrating a motor including a soft magnetic core according to an embodiment of the present invention.

Referring to FIG. 1, a motor 10 according to an embodiment of the present invention, a spindle motor applied to an optical disc drive for rotating a disc, may mainly include a rotor 20 and a stator 40.

The rotor 20 may include a rotor case 22 having a cup shape and including a magnet 25 formed on an outer circumferential portion thereof, the magnet 25 having an annular ring shape and disposed to correspond to a coil 44 of the stator 40. The magnet 25 may be a permanent magnet generating magnetic force having a predetermined magnitude by alternately magnetizing an N pole and an S pole thereof in a circumferential direction.

The rotor case 22 may be configured of a rotor hub 26 having a shaft 50 inserted therein and coupled thereto and a magnet coupling part 28 having the annular ring shaped magnet 25 disposed on an inner circumferential surface thereof. The rotor hub 26 may be formed so as to be bent upwardly in an axial direction in order to maintain unmating force with the shaft 50, and the rotor hub 26 has a chucking mechanism 80 coupled to an outer circumferential surface thereof, the chucking mechanism 80 being capable of mounting a disc D thereon.

The stator 40, referring to all fixed members except for rotating members, may include a base plate 60 having a printed circuit board 62 installed thereon, a sleeve holder 70 pressing and supporting a sleeve 52, a core 42 fixed to the sleeve holder 70, and a winding coil 44 surrounding the core.

The magnet 25 provided on the inner circumferential surface of the magnet coupling part 28 may be disposed to face the winding coil 44, and the rotor 20 may rotate through electromagnetic interactions between the magnet 25 and the winding coil 44. In other words, when the rotor case 22 rotates, the shaft 50 connected to the rotor case 22 rotates.

Meanwhile, terms relating to directions will be defined hereinafter. As viewed in FIG. 1, an axial direction refers to a vertical direction based on a shaft 50, and an outer diameter direction and an inner diameter direction respectively refer to a direction toward an outer edge of a rotor 20 based on the shaft 50, and a direction toward the center of the shaft 50, based on the outer edge of the rotor 20.

The shaft 50 may have a lower end portion 55 exposed downwardly of the sleeve 52 in the axial direction. Here, in order to prevent the shaft 50 from being separated from the sleeve 52 due to high speed rotation of the rotor case 22, the shaft 50 may have a stopper ring coupling groove 54 formed in the lower end portion 55 thereof, the stopper ring coupling groove 54 being coupled to a stopper ring 56 disposed on a bottom surface of the sleeve 52.

The sleeve holder 70 according to the embodiment of the present invention may have the sleeve 52 press-fitted thereinto, the sleeve 52 supporting the shaft 50, and may include a seating part 72 extended in the outer diameter direction and formed in a stepped manner such that the core 42 of the stator may be seated thereon.

Soft Magnetic Core

FIG. 2 is a schematic perspective view illustrating a soft magnetic core according to an embodiment of the present invention.

As shown in FIG. 2, the core 42 formed of a soft magnetic material (hereinafter referred to as a ‘ soft magnetic core’) according to the embodiment of the present invention may include plurality of tooth parts E extended in a radial manner, based on a rotation shaft thereof.

The tooth parts E of the soft magnetic core 42 are regions around which the winding coil (reference numeral 44 of FIG. 1) is wound, and insulation distance between the soft magnetic core 42 and the winding coil 44 needs to be secured such that the motor may be driven stably.

To this end, surfaces of the core 42, particularly, surfaces of the tooth parts E may be provided with an insulating film (not shown) using an insulating resin material such as an epoxy.

Soft magnetic powder particles 110, a basic material of the core 42 according to the embodiment of the present invention, may have an insulating coating layer 120 formed on respective surfaces thereof.

The soft magnetic powder particles 110 may be formed of one or more selected from a group consisting of pure iron (Fe), cobalt (Co), nickel (Ni), and Permalloy, but is not limited thereto.

In a strict sense, pure iron refers to iron having purity of 100% that contains no impurities at all. However, since it is difficult to completely remove impurities such as carbon, nitrogen, silicon, phosphorus, sulphur, and the like therefrom, pure iron generally refers to iron having a higher purity than other types of iron and the term ‘pure iron’ is used in the present invention in a general sense.

Soft magnetism refers to magnetism having a low degree of coercive force and residual magnetization and high permeability in a hysteresis curve and has characteristics in which it is only magnetized when an external magnetic field is applied thereto, while the magnetization is almost lost when the external magnetic field is removed.

The insulating coating layer 120 formed on each surface of the soft magnetic powder particles 110 may be formed of a ceramic or an insulating resin.

The insulating coating layer 120 is provided to decrease eddy current loss by electrically separating the individual soft magnetic powder particles 110 from one another.

The insulating coating layer 120 is not particularly limited, but may include a ceramic or an insulating resin.

The ceramic is not particularly limited, but may be one or more selected from a group consisting of silicon dioxide, sodium silicate, and magnesium oxide, and may also be formed of an oxide having a large resistance.

Further, in order to have excellent magnetic properties, the insulating coating layer 120 may be formed of ferrite.

In the present specification, ferrite is used to collectively refer to a magnetic ceramic including iron oxide.

Since ferrite has magnetism and insulating properties, magnetic flux density of the core using ferrite as the insulating coating layer may be improved, as compared to the case of using the ceramic having no magnetism as the insulating coating layer.

In addition, the insulating resin may include an epoxy resin, and the epoxy resin is not specifically limited, but may be, for example, a phenol based glycidyl ether-type epoxy resin such as a phenol novolac-type epoxy resin, a cresol novolac-type epoxy resin, a naphthol modified novolac-type epoxy resin, a bisphenol A-type epoxy resin, a bisphenol F-type epoxy resin, a biphenyl-type epoxy resin, a triphenyl-type epoxy resin or the like; a dicyclopentadiene-type epoxy resin having a dicyclopentadiene skeleton; a naphthalene-type epoxy resin having a naphthalene skeleton; a dihydroxybenzopyran-type epoxy resin; a glycidylamine-type epoxy resin made of a polyamine such as diaminophenylmethane or the like; a triphenolmethane-type epoxy resin; a tetraphenylethane-type epoxy resin; or a mixture thereof.

Here, an average diameter of the soft magnetic powder particles 110 may be 50 μm to 200 μm.

In the case in which the average diameter of the soft magnetic powder particles 110 is less than 50 μm, the magnetic flux density of the manufactured core may be decreased, and in the case in which the average diameter of the soft magnetic powder 110 exceeds 200 μm, the magnetic flux density is increased, but the core loss is increased, particularly, eddy current loss, which causes defects in a high frequency may be rapidly increased.

Therefore, the soft magnetic powder particles 110 having the average diameter of 50 μm to 200 μm may be prepared.

Further, the insulating coating layer 120 may have a thickness of 50 nm to 1000 nm.

In the case in which the thickness of the insulating coating layer 120 exceeds 1000 nm, the magnetic flux density of the core is decreased, and in the case in which the thickness of the insulating coating layer 120 is less than 50 nm, cracks may occurs in the insulating coating layer at the time of performing a press-molding, such that a tunneling effect may be generated. As a result, an insulating effect may be decreased.

The soft magnetic core according to the embodiment of the present invention may include metal powder particles 130 between the soft magnetic powder particles 110 having the insulating coating layer 120 formed thereon.

The metal powder particles 130 may be formed of a metal having excellent electrical properties.

As shown in FIG. 2, the soft magnetic core according to the embodiment of the present invention may include the soft magnetic powder particles 110 having the insulating coating layer 120 formed thereon; and the metal powder particles 130 having excellent electrical properties and provided on external surfaces of the soft magnetic powder particles 110 or in the interior thereof.

The soft magnetic core including the metal powder particles 130 may have relatively high flexure strength of 100 MPa or more, as compared to the core used in the related art.

Since the soft magnetic core has high flexure strength as described above, damage due to external impacts may be prevented, such that productivity yield may be improved and reliability of a product may be improved.

In addition, the metal powder particles 130 may be formed of a metal having a highly saturated magnetization density.

Therefore, since permeability or magnetic flux density is not decreased due to the metal powder particles 130, and rather, may be increased, back electro motive force (BEMF) may be increased as compared to the core according to the related art.

The following table 1 shows comparison results of molding density, magnetic flux density under conditions of 10 kA/m, and a core loss, with respect to soft magnetic cores (Inventive Examples 1 and 2) in which the metal powder particles 130 according to the embodiment of the present invention were formed using pure iron and soft magnetic cores (Comparative Examples 1 and 2) in which the metal powder particles 130 were formed using aluminum.

In the case of the Inventive Examples, the metal powder particles 130 of the soft magnetic core 42 according to the embodiment of the present invention were manufactured using pure iron.

On the other hand, in the case of the soft magnetic core of Comparative Examples, the metal powder particles were manufactured using aluminum (Al).

The magnetic flux density was measured under the magnetic field of 10 kA/m and the core loss was measured under conditions of 1 T and 400 kHz.

Samples were manufactured to have donut shapes and in this case, each sample has an outer diameter of 25 mm and an inner diameter of 15 mm.

TABLE 1

| | | | Magnetic | |
|---|---|---|---|---|
| | Metal | Molding | flux | Core |
| | powder | density (g/cm³) | density (T) | loss (W/kg) |
| Inventive | Pure iron | 7.5 | 1.57 | 43 |
| Example 1 | | | | |
| Inventive | Pure iron | 7.6 | 1.65 | 38 |
| Example 2 | | | | |
| Comparative | Aluminum | 7.5 | 1.40 | 72 |
| Example 1 | | | | |
| Comparative | Aluminum | 7.6 | 1.50 | 54 |
| Example 2 | | | | |

As shown in Table 1, in the case of the Inventive Examples in which the metal powder particles 130 were formed using pure iron, the magnetic flux density of the cores thereof were higher than the cases of the Comparative Examples in which the metal powder particles were formed of aluminum.

In addition, in the case of the Inventive Examples in which the metal powder particles 130 were formed using pure iron, the values of core loss were lower than the cases of the Comparative Examples in which the metal powder particles were formed of aluminum.

In order to apply the metal powder particles to the motor, the magnetic flux density needs to be 1.5 T or more under the magnetic field of 10 ka/m and the core loss needs to be 50 W/kg or less under the conditions of 1 T and 400 kHz.

Since Comparative Examples 1 and 2 using aluminum have the core loss of 50 W/kg or more, applying the metal powder particles formed of aluminum to the motor may be unsuitable as compared to the case of using pure iron.

That is, in the case of using pure iron as the metal powder particles 130, the molding density may not be decreased while the magnetic flux density may be increased and the core loss may be decreased compared to the case of using aluminum.

The following table 2 shows comparison results of molding density, magnetic flux density under conditions of 10 kA/m, and a core loss, with respect to the soft magnetic core (Inventive Example 1) according to the embodiment of the present invention and soft magnetic cores (Comparative Examples 1 to 3) using Fe—Si crystalline powder or Fe—Cr—Si—B based amorphous metal powder.

In the case of Inventive Example 1, the soft magnetic powder particles 110 and the metal powder particles 130 were formed using pure iron.

Formations and sizes of samples, molding density, magnetic flux density, and a core loss were measured under the same conditions as Table 1.

TABLE 2

| | soft | | Magnetic | Core |
|---|---|---|---|---|
| | magnetic | Molding | flux | loss |
| | core | density (g/cm³) | density (T) | (W/kg) |
| Inventive | Pure iron | 7.6 | 1.65 | 38 |
| Example 1 | | | | |
| Comparative | Fe—3.5% Si | 7.1 | 1.48 | 33 |
| Example 1 | | | | |
| Comparative | Fe—6.5% Si | 6.8 | 1.4 | 20 |
| Example 2 | | | | |
| Comparative | Fe—Cr—Si—B | 5.4 | 1.3 | 15 |
| Example 3 | | | | |

Referring to table 2, it may appreciate that the molding density is highest in the case of Inventive Example 1 in which the soft magnetic core is formed using pure iron.

In addition, it may also be appreciated that Inventive Example 1 has the magnetic flux density higher than those of Comparative Examples 1 to 3.

That is, in the case in which pure iron having a high saturated magnetization density, the permeability or the magnetic flux density is not decreased, and rather, may be increased.

In the case of Comparative Examples 1 to 3, since Fe—Si crystalline powder or Fe—Cr—Si—B based amorphous metal powder having comparatively bad moldability may be used in core molding by adding a binder of about 2.5% thereto, the magnetic flux density is significantly decreased, as shown in table 2.

The following table 3 shows comparison results of molding density, magnetic flux density under conditions of 10 kA/m, and a core loss according to a weight ratio of the soft magnetic powder particles 110 to the metal powder particles 130 in the embodiment of the present invention.

Formations and sizes of samples, molding density, magnetic flux density, and a core loss were measured under the same conditions as Inventive Example 1.

TABLE 3

| | Soft magnetic | | | |
|---|---|---|---|---|
| | powder:metal | Molding | Magnetic | |
| | powder (weight | density | flux | |
| | ratio) | (g/cm³) | density (T) | Core loss (W/kg) |
| Inventive | 9:1 | 7.57 | 1.7 | 49 |
| Example 1 | | | | |
| Inventive | 8:2 | 7.6 | 1.7 | 43 |
| Example 2 | | | | |
| Inventive | 7:3 | 7.65 | 1.65 | 38 |
| Example 3 | | | | |
| Inventive | 6:4 | 7.66 | 1.7 | 46 |
| Example 4 | | | | |

Referring to table 3, as a content of pure iron is increased, the molding density and the magnetic flux density were advantageously increased, but in view of the core loss determining efficiency of the motor, when the content of pure iron exceeds 30%, a threshold ratio, the core loss was again increased.

That is, in the case of Inventive Examples 2 and 4, it may be appreciated that the core loss was again increased as compared to Inventive Example 3.

In addition, in the case of Inventive Example 4 having a higher weight ratio of the metal powder particles than Inventive Example 3, it may be appreciated that molding density is not greatly improved.

Therefore, in consideration of the molding density and the core loss, the case in which the weight ratio of the soft magnetic powder particles to the metal powder particles was 7:3 showed optimal characteristics.

As set forth above, according to embodiments of the present invention, a soft magnetic core formed of insulating coated soft magnetic powder particles and metal powder particles can be provided to improve electrical properties of the soft magnetic core, thereby enhancing intensity thereof.

In addition, the metal powder particles included in order to improve the electrical properties of the soft magnetic core can increase the magnetic flux density of the soft magnetic core, whereby the soft magnetic core having enhanced intensity and improved magnetic flux density can be provided.

While the present invention has been shown and described in connection with the embodiments, it will be apparent to those skilled in the art that modifications and variations can be made without departing from the spirit and scope of the invention as defined by the appended claims.

What is claimed is:

1. A soft magnetic core, comprising:
soft magnetic powder particles having an insulating coating layer formed on respective surfaces thereof; and
metal powder particles disposed between the soft magnetic powder particles.

2. The soft magnetic core of claim 1, wherein the metal powder particles are formed of pure iron or an alloy including iron.

3. The soft magnetic core of claim 1, wherein the soft magnetic powder particles are formed of one or more selected from a group consisting of pure iron (Fe), cobalt (Co), nickel (Ni), and Permalloy.

4. The soft magnetic core of claim 1, wherein the soft magnetic powder particles having the insulating coating layer have an average diameter of 50 μm to 200 μm.

5. The soft magnetic core of claim 1, wherein the insulating coating layer has a thickness of 50 nm to 1000 nm.

6. The soft magnetic core of claim 1, wherein the insulating coating layer includes a ceramic or an insulating resin.

7. The soft magnetic core of claim 6, wherein the ceramic is one or more selected from a group consisting of ferrite, silicon dioxide, sodium silicate, and magnesium oxide.

8. The soft magnetic core of claim 6, wherein the insulating resin is an epoxy resin.

9. The soft magnetic core of claim 1, wherein a weight ratio of the soft magnetic powder particles to the metal powder particles is 7:3.

10. A motor, comprising:
a soft magnetic core including soft magnetic powder particles having an insulating coating layer formed on respective surfaces thereof, and metal powder particles disposed between the soft magnetic powder particles;
a coil wound around the soft magnetic core;
a magnet allowing electromagnetic force to be generated through interactions between the magnet and the coil; and
a rotor rotating a shaft using the electromagnetic force.

11. The motor of claim 10, wherein the metal powder particles are formed of pure iron or an alloy including iron.

12. The motor of claim 10, wherein the soft magnetic powder particles are formed of one or more selected from a group consisting of pure iron (Fe), cobalt (Co), nickel (Ni), and Permalloy.

13. The motor of claim 10, wherein the soft magnetic powder particles having the insulating coating layer have an average diameter of 50 μm to 200 μm.

14. The motor of claim 10, wherein the insulating coating layer has a thickness of 50 nm to 1000 nm.

15. The motor of claim 10, wherein the insulating coating layer includes a ceramic or an insulating resin.

16. The motor of claim 15, wherein the ceramic is one or more selected from a group consisting of ferrite, silicon dioxide, sodium silicate, and magnesium oxide.

17. The motor of claim 15, wherein the insulating resin is an epoxy resin.

18. The motor of claim 10, wherein a weight ratio of the soft magnetic powder particles to the metal powder particles is 7:3.
